(19) United States
(12) Patent Application Publication
(10) Pub. No.: US 2016/0294750 A1
(43) Pub. Date: Oct. 6, 2016

(54) Electronic Message Slide Reveal System and Method

(71) Applicant: VAPORSTREAM, INC., Chicago, IL (US)

(72) Inventors: Aijaz Ansari, Glendale Heights, IL (US); Sudip Ray, Lombard, IL (US); Amit Jindas Shah, Chicago, IL (US)

(73) Assignee: VAPORSTREAM, INC., Chicago, IL (US)

(21) Appl. No.: 14/678,568

(22) Filed: Apr. 3, 2015

(51) Int. Cl. H04L 12/58; G06F 3/0484; G06F 3/0485

(52) U.S. Cl. CPC H04L 51/08; G06F 3/0485; G06F 3/04845

(57) ABSTRACT

An electronic message can be displayed such that as a user provides an instruction to move the display of message content to one side of a display element, the message content is obscured and a message descriptive information is caused to be displayed. Display of message content can be done in an unobscured fashion in certain implementations without display of any message descriptive information. Separated display of message content and message descriptive information may provide a benefit of reduced traceability of the electronic message and/or reduced ability to screen capture an electronic message.

### FIELD OF INVENTION

The present invention generally relates to the field of electronic messaging. In particular, the present invention is directed to an electronic message slide reveal system and method.

### BACKGROUND

Sometimes a user would like to view, and/or send to someone else to view, an electronic message. Several mechanisms exist for a user to transmit an electronic message from one computing device to another computing device. A screen capture of an electronic message may create a record of the message content and identifying information about the message (e.g., sending username, recipient username, etc.). Applications for reducing an ability to screen capture an electronic message have been attempted. Snapchat, Inc., for example, provides an app (SNAPCHAT) that allows a sending user to set a fixed amount of time that a recipient of an image or video has to view the image or video before the image or video is no longer viewable by the recipient. A recipient user can screencapture that image prior to the expiration of the time period for viewing. A screencapture creates a captured image of the display screen of the computing device and, thus, can preserve the received image or a still of the received video. ContentGuard, Inc. markets an app, YOVO, which allows display of an image with a filter over the image. The filter makes a screencaptured image appear less desirable. The filter seems to move across the display of the image while the image is displayed such that any screencapture will also include the filter.

### SUMMARY OF THE DISCLOSURE

In one example implementation, a computer-implemented method of handling an electronic message is provided. The method includes displaying a message content display to a first user via a display element of a user device, the message content display including a message content originating from a first originating user; receiving an instruction from the first user to slide the message content; and obscuring, in response to the instruction, the message content from view via the display element; sliding the display of the message content to one side of the display element; and displaying a message descriptive information regarding the message content such that while the message descriptive information is displayed the message content is not displayed in an unobscured form

In another example implementation, a machine-readable hardware storage medium comprising machine executable instructions implementing a method of handling an electronic message is provided. The instructions include a set of instructions for displaying a message content display to a first user via a display element of a user device, the message content display including a message content originating from a first originating user; a set of instructions for receiving an instruction from the first user to slide the message content; a set of instructions for, in response to the instruction, obscuring the message content from view via the display element; a set of instructions for sliding the display of the message content to one side of the display element; and a set of instructions for displaying a message descriptive information regarding the message content such that while the message descriptive information is displayed the message content is not displayed in an unobscured form.

In yet another example implementation, a system for handling an electronic message, the instructions comprising: a means for displaying a message content display to a first user via a display element of a user device, the message content display including a message content originating from a first originating user; a means for receiving an instruction from the first user to slide the message content; a means for, in response to the instruction, obscuring the message content from view via the display element; a means for sliding the display of the message content to one side of the display element; and a means for displaying a message descriptive information regarding the message content such that while the message descriptive information is displayed the message content is not displayed in an unobscured form.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one exemplary implementation of a method of displaying an electronic message;

FIG. 2 illustrates one example of a portable handheld computing device;

FIG. 3 illustrates another example of a portable handheld computing device;

FIG. 4 illustrates one exemplary implementation of a display of an example message content via a computing device;

FIG. 5 illustrates another exemplary implementation of a display of another example message content via a computing device;

FIG. 6 illustrates one example diagrammatic representation of one implementation of a computing device;

FIG. 7A illustrates yet another exemplary implementation of a display of an example message content via a computing device;

FIG. 7B illustrates an example of a message descriptive information corresponding to the message content of FIG. 7A;

FIG. 7C illustrates one example implementation of a slide/reveal display of the message content of FIG. 7A and corresponding message descriptive information;

FIG. 7D illustrates another example implementation of a slide/reveal display of the message content of FIG. 7A and corresponding message descriptive information;

FIG. 7E illustrates yet another example implementation of a slide/reveal display of the message content of FIG. 7A and corresponding message descriptive information;

FIG. 7F illustrates still another example implementation of a slide/reveal display of the message content of FIG. 7A and corresponding message descriptive information;

FIG. 8A illustrates still another exemplary implementation of a display of an example message content via a computing device;

FIG. 8B illustrates an example of a message descriptive information corresponding to the message content of FIG. 8A;

FIG. 8C illustrates one example implementation of a slide/reveal display of the message content of FIG. 8A and corresponding message descriptive information;

FIG. 8D illustrates another example implementation of a slide/reveal display of the message content of FIG. 8A and corresponding message descriptive information;

FIG. 8E illustrates yet another example implementation of a slide/reveal display of the message content of FIG. 8A and corresponding message descriptive information;

FIG. 9 illustrates one example of a networking environment; and

FIG. 10 illustrates another example of a networking environment.

### DETAILED DESCRIPTION

Electronic messaging allows a sending user to send a message electronically to one or more recipient users (e.g., from one user device to another user device). Electronic messaging can occur in a variety of ways. Example ways for sending an electronic message include, but are not limited to, electronic mail (e.g., a message sent using a Simple Mail Transfer Protocol (SMTP)), text messaging (e.g., a message sent via a Short Message Service (SMS), a message sent via a Multimedia Messaging Service (MMS)), instant messaging, personal messaging (e.g., via a private messaging service, such as Twitter, Facebook, Snapchat, Instagram, etc.), recordless messaging (e.g., via an app, such as Vaporstream or Slycr, both by Vaporstream, Inc.), and any combinations thereof

An electronic message typically includes a message content and descriptive information (e.g., header information). Display of message content can occur separated from display of message descriptive information. Embodiments for displaying message content with an ability to slide the message content to a side of a display to reveal display of message descriptive information with an obscuring of message content are described herein.

Example message content includes, but is not limited to, a text information, an electronic image (e.g., a photograph), a graphic image, a video, an audio element, a geolocation coordinate, a sticker graphic and/or image, an emoji graphic and/or image, and any combinations thereof. Example text information includes, but is not limited to, Unicode text (e.g., text using a UTF-8 encoding, a UTF-16 encoding, etc.), American Standard Code for Information Interchange (ASCII) text, HyperText Markup Language (HTML) text, Multi-Purpose Internet Mail Extensions (MIME) text, Extensible Markup Language (XML) text, another text standard, and any combinations thereof. A message content may also include one or more file attachments. Examples of a file attachment include, but are not limited to, a document file (e.g., a word processor file, a spreadsheet file, etc.), a portable document format file (e.g., an Adobe Acrobat file), an electronic image file, a video file, an audio file, and any combinations thereof. Examples of data formats for an electronic image and examples of video formats are discussed further below with respect to FIG. 6.

Electronic message descriptive information is information that identifies one or more characteristics of the electronic message, but that is not part of the message content. In one exemplary aspect, electronic message descriptive information may be part of an electronic message header (e.g., to, from, date sent, subject, etc.). Example electronic message descriptive information includes, but is not limited to, information that uniquely identifies a sending user, information that uniquely identifies a recipient user, a date and/or time corresponding with the electronic message (e.g., a date and/or time of creation and/or delivery), and any combinations thereof. Example information that may uniquely identify a user includes, but is not limited to, an electronic messaging address (e.g., an email address), a display name, a system login name, an alias identifier that may be correlated to a user (e.g., via a crossover table association of a system), an image representing a user, an actual name of a sender, an actual name of a recipient, a nickname of a sender, a nickname of a recipient, a user avatar, a phone number of a user, and any combinations thereof

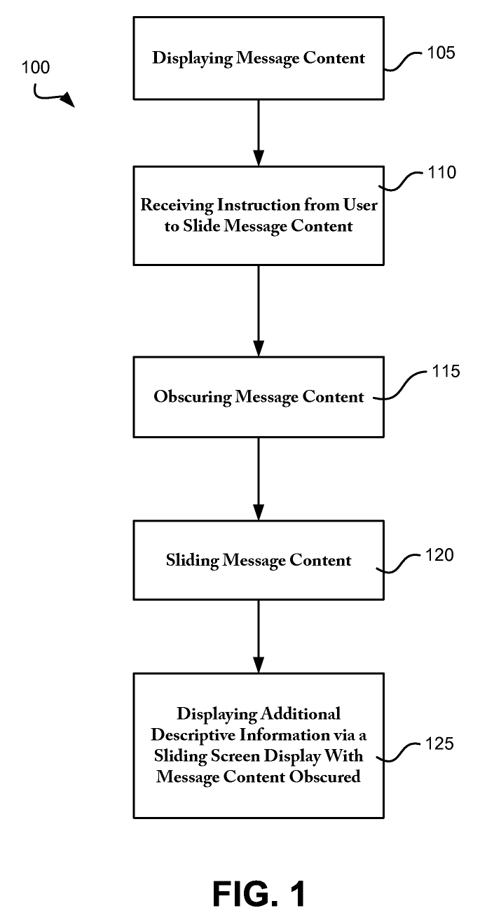

FIG. 1 illustrates one exemplary embodiment of a method 100 of handling an electronic message. At step 105, a message content is displayed via a user computing device.

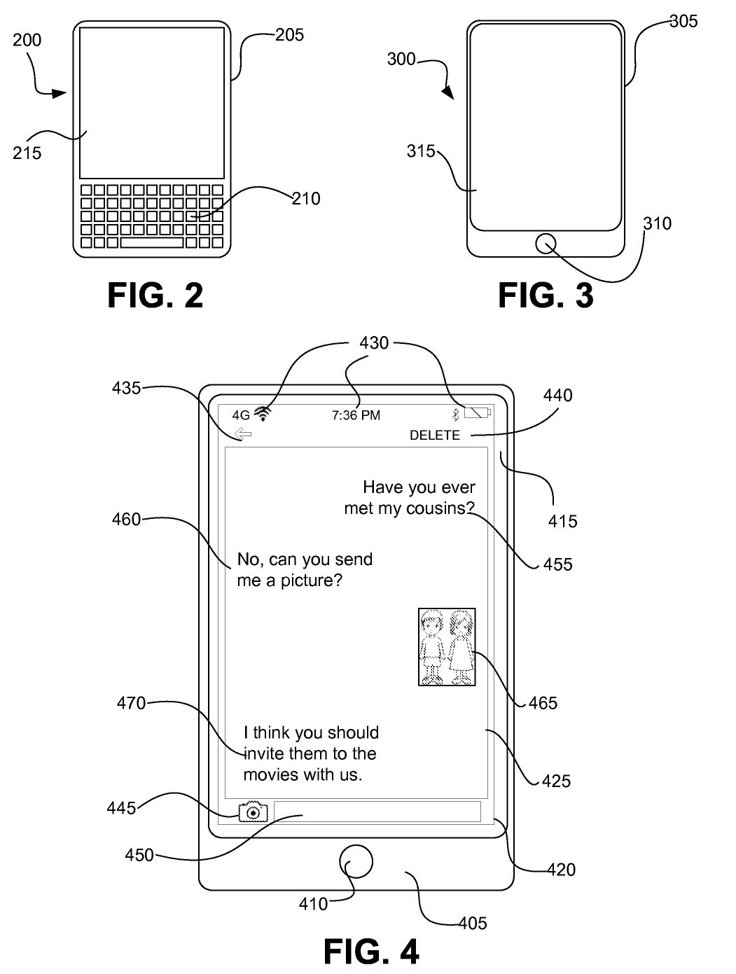

A computing device is any machine that is capable of executing machine-executable instructions to perform one or more tasks. Examples of a computing device are discussed below (e.g., with respect to FIGS. 2, 3, and 6). A computing device may include and/or be programed with specific machine-executable instructions and include required circuitry and components such that the combination of the circuitry/components and the instructions allow it to perform as a specialized machine in one or more of the implementations disclosed in the current disclosure.

In one exemplary implementation, a message content is displayed in a message content display region via a display element of a computing device. Examples of a display element are discussed below (e.g., with respect to FIG. 6). A message content display region may have an area that corresponds to an area of an image for which a portion is to be displayed.

A message content display region may occupy any amount of the displayable portion of a display element. A displayable portion of a display element is the portion of the display element capable of producing a visible display to a user. In one example, a message content display region occupies substantially the entire displayable portion of a display element. In another example, a message content display region occupies part of the displayable portion of a display element.

A message content display region can have a variety of shapes and configurations. Examples of a shape for a message content display region include, but are not limited to, a square, a rectangle, a circle, a polygon, an ellipse, a triangle, a diamond, and any combinations thereof. In one example, a message content display region has the shape of a message content for which the message content display region is configured to display. In another example, a message content display region has a shape different from a message content for which the message content display region is configured to display.

FIG. 2 illustrates one example of a portable handheld computing device in the form of a smartphone 200. Smartphone 200 includes a body 205, a keyboard user input element 210, and a display element 215. Display element 215 may be a touch screen to provide a user with additional input interface capabilities. A computing device, such as smartphone 200, may be used in a variety of ways with respect to any of the implementations and/or embodiments described herein. Exemplary ways to utilize smartphone 200 (or another computing device) include, but are not limited to, creating an electronic message, message content, and/or any portion thereof; transmitting an electronic message, message content, message descriptive information (e.g., header information), and/or any portion thereof; storing an electronic message, message content, message descriptive information (e.g., header information), and/or any portion thereof; receiving an electronic message, message content, message descriptive information (e.g., header information), and/or any portion thereof; acquiring a message content, receiving an input of a message content; displaying an electronic message, message content, message descriptive information (e.g., header information), and/or any portion thereof; providing an interface to a user of the computing device; receiving an instruction (and/or other input) from a user of the computing device; and any combinations thereof

FIG. 3 illustrates another example of a portable handheld computing device in the form of a smartphone 300. Smartphone 300 includes a body 305, a button user input element 310, and a display element 315. Display element 315 may be a touch screen to provide a user with additional input interface capabilities. A computing device, such as smartphone 300, may be used in a variety of ways with respect to any of the methods described herein.

A message content display region may include message content originated by any number of users. In one example, a message content display region includes message content originated by a single user. In another example, a message content display region includes message content originated by a plurality of user's. In one such example, a message content display region includes display of a message thread including message content originated by two or more users.

FIG. 4 illustrates one exemplary implementation of a display of an example message content. A user device 405 includes an input element 410 and a display element 415. Display element 415 may be a touch screen to provide a user with additional input interface capabilities. Display element 415 includes a displayable portion 420 including a message content display region 425. In this example, displayable portion 420 also includes the display of several operating environment graphics 430. Operating environment graphics 430 are an optional display. In this example, operating environment graphics 430 include indications for showing mobile network status (e.g., “4G”), WiFi network status, current device time (“7:36 PM”), Bluetooth network status, and battery status. In other examples, fewer, more, or no operating environment graphics may be displayed via a computing device and not impact the operation of the sliding features of any of the implementations and embodiments described herein.

Displayable portion 420 also includes a display of a navigation control 435 (e.g., for navigating away from the display of message content via message content display region 425), a display of a message content delete control 440, a display of a camera control 445 (e.g., to navigate to a camera functionality of device 405 for acquiring an electronic image, such as to include in a message content), a display of a text entry field 450 (e.g., to allow for entry of text by a user for inclusion in a message content).

In the example shown in FIG. 4, the message content displayed via message content display region 425 includes message content from two originating users, including a first message content 455 from a first originating user, a reply message content 460 from a second originating user, a third message content 465 from the first originating user, and a fourth message content 470 from the second originating user. In one exemplary aspect, message contents 455, 460, 465, and 470 form a message thread between first and second originating users.

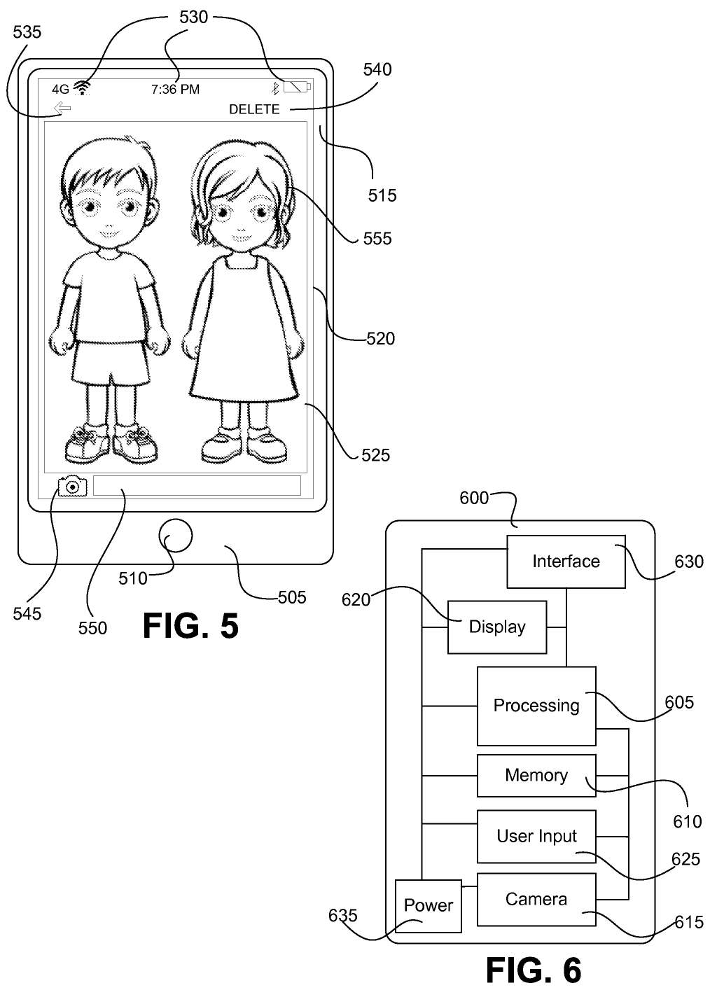

FIG. 5 illustrates another exemplary implementation of a display of an example message content. A user device 505 includes an input element 510 and a display element 515. Display element 515 may be a touch screen to provide a user with additional input interface capabilities. Display element 515 includes a displayable portion 520 including a message content display region 525. In this example, displayable portion 520 also includes the display of several operating environment graphics 530. Operating environment graphics 530 are an optional display. In this example, operating environment graphics 530 include indications for showing device time and mobile network, WiFi, Bluetooth network, and battery status. In other examples, fewer, more, or no operating environment graphics may be displayed via a computing device and not impact the operation of the sliding features of any of the implementations and embodiments described herein.

Displayable portion 520 also includes a display of a navigation control 535 (e.g., for navigating away from the display of message content via message content display region 525), a display of a message content delete control 540, a display of a camera control 545 (e.g., to navigate to a camera functionality of device 505 for acquiring an electronic image, such as to include in a message content), a display of a text entry field 550 (e.g., to allow for entry of text by a user for inclusion in a message content). The message content displayed via message content display region 525 includes an electronic image 555. In one example, electronic image 555 is originated at device 505 and included as the message content of an electronic message using device 505. In another example, electronic image 555 is originated at a device other than device 505 and transferred to device 505 as part of an electronic message prior to display.

An electronic message, including the corresponding message content, typically originates with a sending user for eventual transmission to a recipient user. In one such example, a message content is originated in an electronic message at a computing device by a user of that computing device and displayed via a display element of that computing device. In another such example, a message content is originated at a sending user's computing device and transferred to a recipient user's computing device for display at the recipient user's computing device. Message content may originate in a variety of ways and be included with an electronic message. Example ways of originating message content include, but are not limited to, receiving an input of text from a user at a computing device (e.g., via a keyboard or other user input element), acquiring an electronic image, acquiring a video, receiving an input of a graphical element from a user at a computing device, and any combinations thereof.

Referring again to FIG. 1, at step 110, an instruction is received from a user of the computing device to slide the message content. A slide of a display of message content is a movement of the message content to one or more sides of a display (e.g., with a sliding movement of a previously undisplayed display of another item, such as message descriptive information, onto the display).

Example ways to slide message content on a screen display include, but are not limited to, using a touch screen to input an instruction to slide message content, using a swipe gesture on a screen element to input an instruction to slide message content, using a pointing device to select a message content and dragging the message content in a direction, using an arrow key of a keyboard to direct the sliding of a message content in a direction on a screen display, using a touch input to activate a button to direct the sliding of a message content in a direction on a screen display, and any combinations thereof.

At step 115, the message content is obscured from view. The message content is obscured from view via the message content display such that when additional descriptive information related to the message content is allowed to come into view by sliding the message content display (e.g., at step 120) and revealing a display of the additional descriptive information (e.g., at step 125), the message content and the additional descriptive information are not visible via a screen display at the same time.

Example ways to obscure message content include, but are not limited to, graphically blocking display of message content, blurring the display of message content, applying a blocking filter over message content, replacing original message content in a display with a message content substitute element, and any combinations thereof In one example, obscuring message content completely prevents the visibility of the original message content.

Examples of a message content substitute element include, but are not limited to, a greyscale graphical element, a black graphical element, a white graphical element, a colored graphical element, a replacement text (e.g., the text “redacted” for replacing any original message content text), a replacement graphic (e.g., a graphical element indicated “content redacted” or other statement or replacement of original message content), a replacement image, a blurred version of the original message content, a version of the original message content having a filter applied thereover to obscure the message content, a version of the original message content having one or more image parameters modified, a user-defined substitute displayable element (e.g., defined and/or selected via an interface provided to a user), and any combinations thereof Examples of an image parameter include, but are not limited to, a picture quality parameter, an image exposure parameter, an image lighting parameter, an image aperture parameter, an image zoom parameter, an image size parameter, an image color, an image contrast, an image luminance and any combinations thereof. An image parameter can be modified in a variety of ways. Ways of modifying an image parameter include, but are not limited to, providing a user of a computing device with an interface for providing an instruction for modifying an image parameter, automatically modifying an image parameter, modifying an image parameter based on a predetermined modification, and any combinations thereof. In one example, a message content substitute element is a displayable portion in which data is provided to a display element of a computing device to display that data in place of an original message content. A message content substitute element may be in the form of machine-displayable information stored in a memory of a computing device. A message content substitute element may be provided to a computing device used for display of the message content substitute element by another computing device. A message content substitute element may be created by a computing device (e.g., a sending computing device, an intermediate computing device, a recipient computing device used to display the substitute portion). In one example, a message content substitute element is created using machine-executable instructions. A message content substitute element may be created automatically (e.g., using machine executable instructions and a processing element).

At step 120, the message content display is moved to one side of the displayable portion of the display element and at step 125, electronic message descriptive information is displayed as the moving message content display (i.e., with obscured message content) is moved to the side. Movement of the message content display to one side of the display element may cause a portion of the message content display to move off the side of the displayable portion of the display element such that a portion or all of the message content display and its included obscured message content may become not displayed. Movement of the message content display may be to any side of the display element. In one example, a message content display occupies a rectangular portion of a rectangular display element. In one such example, movement of the message content display is to one side of the rectangular display element (e.g., left, right, top, bottom, and/or in the direction of one or more corners). In another example, a message content display occupies a portion of a circular or oval display element. In one such example, movement of the message content display is to the outside of the circular or oval display in any direction.

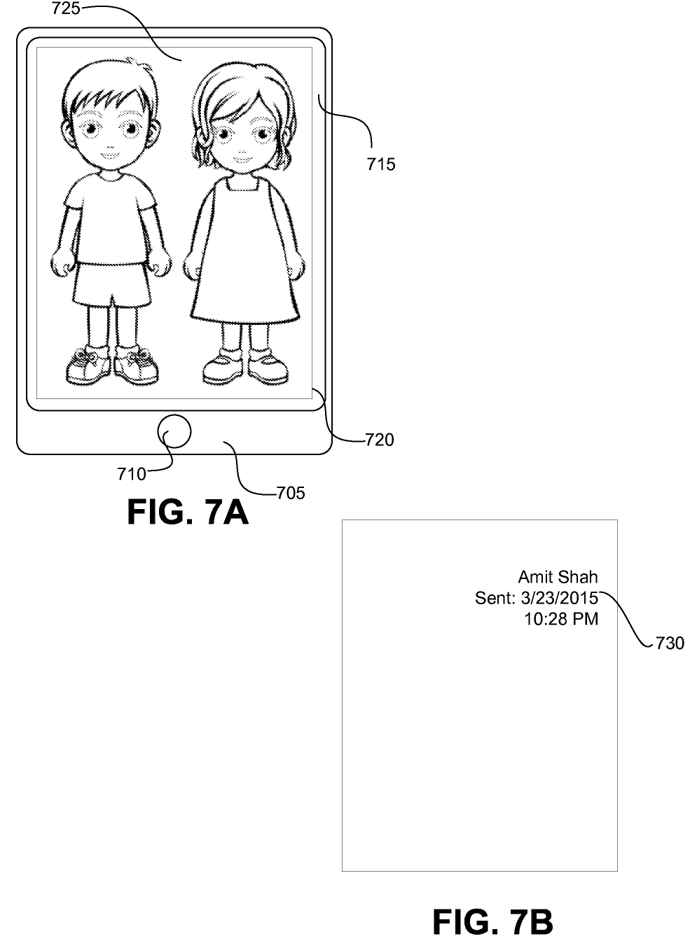

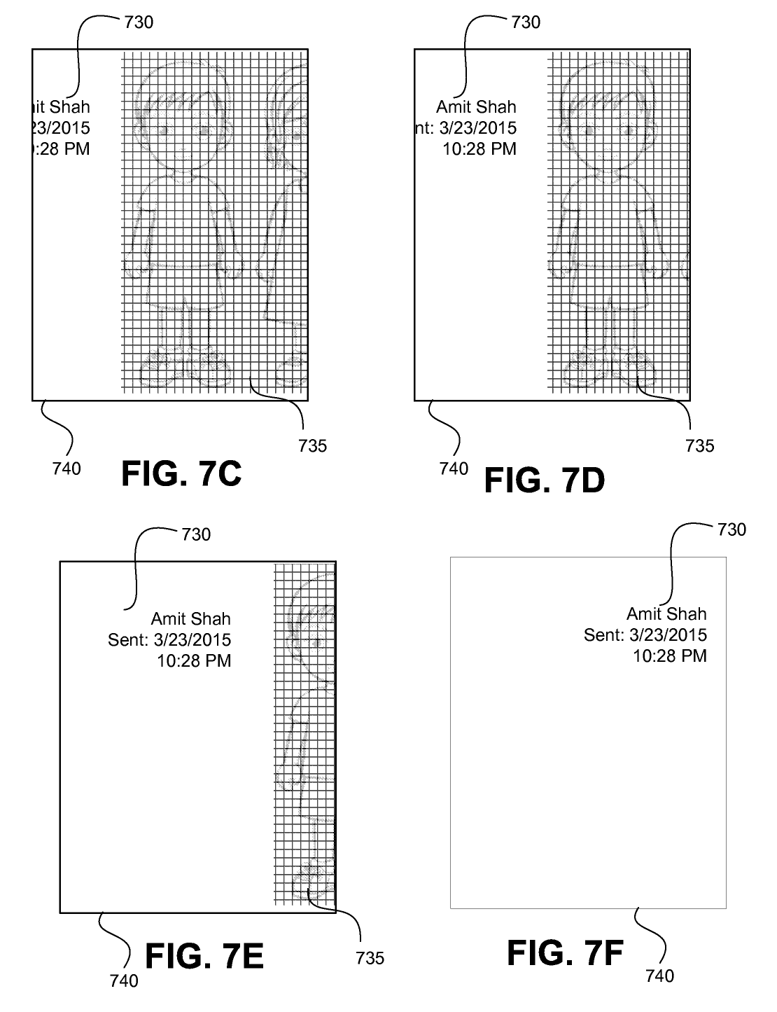

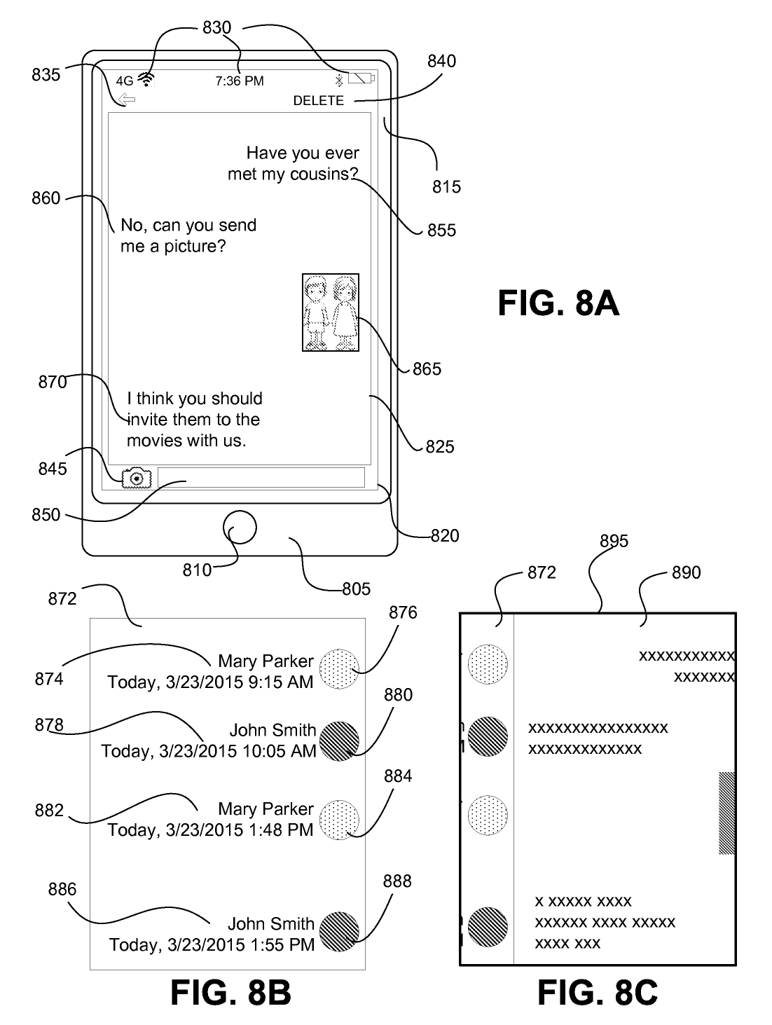

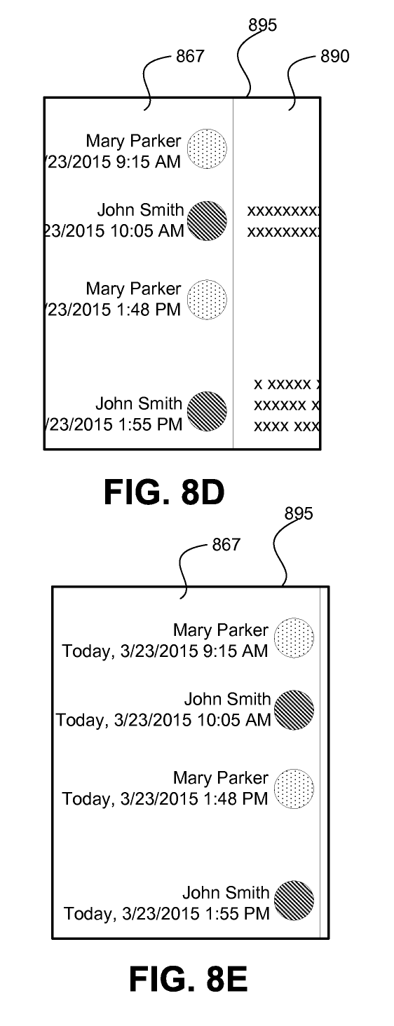

In one exemplary aspect, movement of a message content display to a side of a display element provides a portion of the display element where the message content display was prior to the movement. In one example, a display of electronic message descriptive information occurs in the portion of the display element once occupied by the message content display. In one such example, movement of a message content display to a side of display element (e.g., off of the side of the display element) has a corresponding revealing of a display of electronic message descriptive information relating to the message content in the message content display. Exemplary implementation of such movement are shown below with respect to the message display examples of FIGS. 7 and 8.

While message content is displayed in an unobscured fashion (e.g., via a message content display), the display of message content descriptive information may be restricted in a variety of ways. Prevention of display of message content descriptive information at the same time as unobscured message content may provide one or more benefits to a user. Examples of benefits include, but are not limited to, reduced traceability of an electronic message, reduced likelihood and/or prevention of screen capturing message content and message content descriptive information at the same time, and any combinations thereof. Any one or more types of message content descriptive information may not be displayed at the same time as unobscured message content. In one example, when a message content is being displayed to a user via a display element, a unique identifier of an originating user (e.g., a username) of the message content is not displayed via the display element. In one such example, as a user identifier is revealed as a message content display is moved to a side of a display element, any related message content in the message content display is obscured. In another example, when a message content is being displayed to a user via a display element, a username of one or more originating users related to the message content, an alias of one or more originating users related to the message content, an avatar of one or more originating users related to the message content, a date and/or time of creation of the message content, a date and/or time of transmission of the message content, and a date and/or time of receipt of the message content are not visible via the display element.

A display of a message content may include a display of a message user icon. A message user icon is a non-unique identifier of a user assigned to an individual electronic message or electronic message thread for aiding in distinguishing which portions of message content are originated by different users in a message thread. A message user icon does not provide information that in itself identifies a user outside of a given message thread (i.e., an icon is non-identifying from one electronic message thread to another). A message user icon differs from a user avatar in that a user avatar may be the same from one message or message thread to another (e.g., could be used to uniquely identify a user). Example message user icons include, but are not limited to, a graphical element, a color, a colored text, a colored graphical element, and any combinations thereof A message user icon may be assigned to a message content in a message thread in a variety of ways. In one example, a message user icon is automatically assigned for message content from one user in a single message thread. In one such example, when the same user creates an additional message thread (e.g., starts an electronic message to a new user, starts an additional electronic message to a same user as a recipient in a first electronic message, etc.) a different message user icon is assigned to a message content of the additional message thread.

As discussed above, a computing device is any machine that is capable of executing machine-executable instructions to perform one or more tasks. Examples of a computing device include, but are not limited to, a smartphone, a tablet, an electronic book reading device, a workstation computer, a terminal computer, a server computer, a personal digital assistant (PDA), a mobile telephone, a portable and/or handheld computing device, a wearable computing device (e.g., a watch), a web appliance, a network router, a network switch, a network bridge, one or more application specific integrated circuits, an application specific programmable logic device, an application specific field programmable gate array, any machine capable of executing a sequence of instructions that specify an action to be taken by that machine (e.g., an optical, chemical, biological, quantum and/or nanoengineered system and/or mechanism), and any combinations thereof. In one example, a computing device is a smartphone. A computing device may utilize any of a variety of known or yet to be developed operating systems. Examples of an operating system include, but are not limited to, Apple's iOS, Blackberry operating system, Amazon's Fire OS, Google's Android operating system, Microsoft's Windows Phone operating system, Samsung's Bada operating system, Microsoft's Windows operating system, Apple's Operating System X, a Linux-kernel based operating system, and any combinations thereof

FIG. 6 illustrates one example diagrammatic representation of one implementation of a computing device 600. Computing device 600 includes a processing element 605, a memory 610, a camera 615, a display component 620, a user input 625, an external interface element 630, and a power supply 635. Processing element 605 includes circuitry and/or machine-executable instructions (e.g., in the form of firmware stored within a memory element included with and/or associated with processing element 605) for executing instructions for completing one or more tasks (e.g., tasks related to one or more of the implementations, methodologies, features, aspects, and/or examples described herein). Examples of a processing element include, but are not limited to, a microprocessor, a microcontroller, one or more circuit elements capable of executing a machine-executable instruction, and any combinations thereof.

Two devices, components, elements, and or other items may be associated with each other in a variety of ways. Example ways to associate two items include, but are not limited to, one item being an internal component to another item, one item being an external portion to another item (e.g., an external LED touch screen of a smartphone computing device), one item being connected externally to another item via a wired connection (e.g., a separate LED display device connected via a wire to a computing device, an external memory device connected via a Universal Serial Bus (USB) connection to a computing device, two items connected via Ethernet), one item being connected externally to another item via a wireless connection (e.g., two devices connected via a Bluetooth wireless, cellular, WiFi connection and/or other wireless connection), one item connected to another item via an external port or other connector of the other item (e.g., a USB flash drive, such as a “thumb drive” plugged into an external USB port of a computing device), one item removeably connected to another item, one item being internally connected to another item, and any combinations thereof.

Memory 610 may be any device capable of storing data (e.g., data representing an electronic message or any portion thereof), machine-executable instructions, and/or other information related to one or more of the implementations, methodologies, features, aspects, and/or examples described herein. A memory, such as memory 610, may include a machine-readable hardware storage medium. Examples of a memory include, but are not limited to, a solid state memory, a flash memory, a random access memory (e.g., a static RAM “SRAM”, a dynamic RAM “DRAM”, etc.), a magnetic memory (e.g., a hard disk, a tape, a floppy disk, etc.), an optical memory (e.g., a compact disc (CD), a digital video disc (DVD), a Blu-ray disc (BD); a readable, writeable, and/or re-writable disc, etc.), a read only memory (ROM), a programmable read-only memory (PROM), a field programmable read-only memory (FPROM), a one-time programmable non-volatile memory (OTP NVM), an erasable programmable read-only memory (EPROM), an electrically erasable programmable read-only memory (EEPROM), and any combinations thereof. Examples of a flash memory include, but are not limited to, a memory card (e.g., a MultiMediaCard (MMC), a secure digital (SD), a compact flash (CF), etc.), a USB flash drive, another flash memory, and any combinations thereof.

A memory and/or a portion thereof may be removable from device 600. A memory, such as memory 610, may include and/or be associated with a memory access device. For example, a memory may include a medium for storage and an access device including one or more circuitry and/or other components for reading from and/or writing to the medium. In one such example, a memory includes a disc drive for reading an optical disc. In another example, a computing device may include a port (e.g., a Universal Serial Bus (USB) port) for accepting a memory component (e.g., a removable flash USB memory device).

A memory, such as memory 610, may include any information stored thereon. Examples of information that may be stored via a memory associated with a computing device include, but are not limited to, an electronic message, a message listing of electronic messages, a message content, a descriptive information related to a message content, a header information of an electronic message, a message content substitute element, a video, a still image, one or more portions of a frame of a video, one or more portions of a still image, machine-executable instructions embodying any one or more of the aspects and/or methodologies of the present disclosure (e.g., instructions for displaying a divided image, instructions for providing an interface, etc.), an operating system for a computing device, an application program a program module, program data, a basic input/output system (BIOS) including basic routines that help to transfer information between components of a computing device, and any combinations thereof.

In one example, a message content (e.g., an image, a video, a graphic, and/or a text element) is stored on memory 610 after origination at computing device 600 (e.g., via acquisition by a camera associated with computing device 600, via input using a user input of computing device 600). In another example, a message content is stored on memory 610 after acquisition via electronic transfer to computing device 600. In yet another example, a message content is stored on memory 610 after input by a user of computing device 600. Examples of electronic transfer include, but are not limited to, attachment to an electronic message (e.g., an email, an SMS/MMS message, a Snapchat message, a Facebook message, etc.), component of an electronic message, downloaded/saved from an online/Internet posting, transfer from a memory element removable from device 600, wireless transfer from another computing device, wired transfer from another computing device, and any combinations thereof.

Device 600 includes camera 615 connected to processing element 605 (and other components). Camera 615 may be utilized for acquiring one or more images and/or one or more videos for use with one or more of the implementations, embodiments, examples, etc. of the current disclosure. Examples of a camera include, but are not limited to, a still image camera, a video camera, and any combinations thereof. Acquisition of an electronic image and/or a video can occur in a variety of ways. Example ways to acquire an electronic image and/or a video include, but are not limited to, using a camera built into a computing device to capture an electronic image and/or a video, using a camera associated with a computing device to capture an electronic image and/or a video, accessing an electronic image and/or a video stored on a memory element of a computing device, accessing an electronic image and/or a video stored on a memory element associated with a computing device, receiving an electronic image and/or a video over a network connection (e.g., as an attachment to an electronic message, as a download from an Internet posting, etc.), and any combinations thereof. In one example, an image is captured using a camera and stored (e.g., temporarily in RAM or other volatile memory, as an image file in non-volatile memory, etc.) in a memory element of a computing device from where it is acquired. In another example, an image previously saved as an image file on a memory element of a computing device is acquired by accessing the image file. In yet another example, a video is captured using a camera and stored (e.g., temporarily in RAM or other volatile memory, as a video file in non-volatile memory, etc.) in a memory element of a computing device from where it is acquired. In still another example, a video previously saved as a video file on a memory element of a computing device is acquired by accessing the video file.

An electronic image can be any type of image in an electronic form. Various data formats for electronic images are known and others may be developed in the future, any of which may be utilized in one or more implementations and embodiments disclosed herein. Example data formats for an electronic image include, but are not limited to, joint photographic experts group (JPEG), JPEG file interchange format (JIFF), exchange image file format (Exif), tagged image file format (TIFF), a RAW format (e.g., ISO 12234-2, TIFF/EP, proprietary RAW formats of various camera manufacturers), graphics interchange format (GIF), Windows bitmap format (BMP), portable network graphics format (PNG), portable pixmap file format (PPM), portable graymap file format (PGM), portable bitmap file format (PBM), WebP format, an HDR raster format, JPEG XR format, SGI format, personal computer exchange (PCX) format, computer graphics metafile (CGM), scalable vector graphics (SVG), a raster file format, a vector file format, and any combinations thereof.

Various video formats are known and others may be developed in the future, any of which may be utilized in one or more implementations and embodiments disclosed herein. Example video formats include, but are not limited to, Windows Media Video (WMV) format, a Flash Video (FLV) format, a QuickTime File Format (MOV), a WebM format, a Moving Pictures Experts Group (MPEG) format (e.g., MPEG-1, MPEG-2, MPEG-4), an M4V format, a RealMedia (RM) format, a RealMedia Variable Bitrate (RMVB) format, an AVI format, a Matroska Multimedia (MKV) format, a Video Object (VOB) format, and any combinations thereof. A video may be in the form of one or more streams of video. In one exemplary aspect, a frame is a display of a visual image and a video typically includes a plurality of frames displayed in succession. Different video formats may approach the storage of data representing a frame in different ways. For example, data representing a frame may be stored in a compressed format. In one example, compression may store less than all of the data for every frame (e.g., where one or more pixels of multiple frames in the video are the same). Examples of a compression format include, but are not limited to, H.120, H.261, H.262, H.263, H.264, H.265, VC-2, MPEG-2, MPEG-4, and any combinations thereof.

Display component 620 is connected to processing element 605 for providing a display according to any one or more of the implementations, examples, aspects, etc. of the current disclosure (e.g., providing an interface, displaying separated display screens for each of a plurality of portions of an image, etc.). A display component 620 may include a display element, a driver circuitry, display adapter, a display generator, machine-executable instructions stored in a memory for execution by a processing element for displaying still and/or moving images on a screen, and/or other circuitry for generating one or more displayable images for display via a display element. Examples of a display element include, but are not limited to, a computer monitor, a liquid crystal display (LCD) display screen, a light emitting diode (LED) display screen, a touch display, a cathode ray tube (CRT), a plasma display, and any combinations thereof. A display element can have a variety of shapes and configurations. Examples of a shape for a display element include, but are not limited to, a square, a rectangle, a circle, a polygon, an ellipse, a triangle, a diamond, and any combinations thereof. In one example, a display element is integrated with device 600 (e.g., a built-in LCD touch screen). In another example, a display element is associated with device 600 in a different fashion (e.g., an external LCD panel connected via a display adapter of display component 620).

A display element may include, be connected with, and/or associated with adjunct elements to assist with the display of still and/or moving images. Examples of an adjunct display element include, but are not limited to, a display generator (e.g., image/image display circuitry), a display adapter, a display driver, machine-executable instructions stored in a memory for execution by a processing element for displaying still and/or moving images on a screen, and any combinations thereof

User input 625 is configured to allow a user to input one or more commands, instructions, and/or other information to computing device 600. For example, user input 625 is connected to processing element 605 (and optionally to other components directly or indirectly via processing element 605) to allow a user to interface with computing device 600 (e.g., to actuate camera 615, to input text for a message content, to input instructions for sliding a display, to input instructions for designating a recipient of an image, and/or to perform one or more other aspects and/or methodologies of the present disclosure). Examples of a user input include, but are not limited to, a keyboard, a keypad, a screen displayable input (e.g., a screen displayable keyboard), a button, a toggle, a microphone (e.g., for receiving audio instructions, for receiving an audio component of a message content), a pointing device, a joystick, a gamepad, a cursor control device (e.g., a mouse), a touchpad, an optical scanner, a video/image capture device (e.g., a camera), a touch screen of a display element, a pen device (e.g., a pen that interacts with a touch screen and/or a touchpad), and any combination thereof. It is noted that camera 615 and/or a touch screen of a display element of display component 620 may function also as an input element. It is also contemplated that one or more commands, data, and/or other information may be input to a computing device via a data transfer over a network and/or via a memory device (e.g., a removable memory device). A user input, such as user input 625, may be connected to computing device 600 via an external connector (e.g., an interface port).

External interface element 630 includes circuitry and/or machine-executable instructions (e.g., in the form of firmware stored within a memory element included with and/or associated with interface element 630) for communicating with one or more additional computing devices and/or connecting an external device to computing device 600. An external interface element, such as element 630, may include one or more external ports. In another example, an external interface element includes an antenna element for assisting with wireless communication. Examples of an external interface element include, but are not limited to, a network adapter, a Small Computer System Interface (SCSI), an advanced technology attachment interface (ATA), a serial ATA interface (SATA), an Industry Standard Architecture (ISA) interface, an extended ISA interface, a Peripheral Component Interface (PCI), a Universal Serial Bus (USB), an IEEE 1394 interface (FIREWIRE), and any combinations thereof. A network adapter includes circuitry and/or machine-executable instructions configured to connect a computing device, such as computing device 600, to a network.

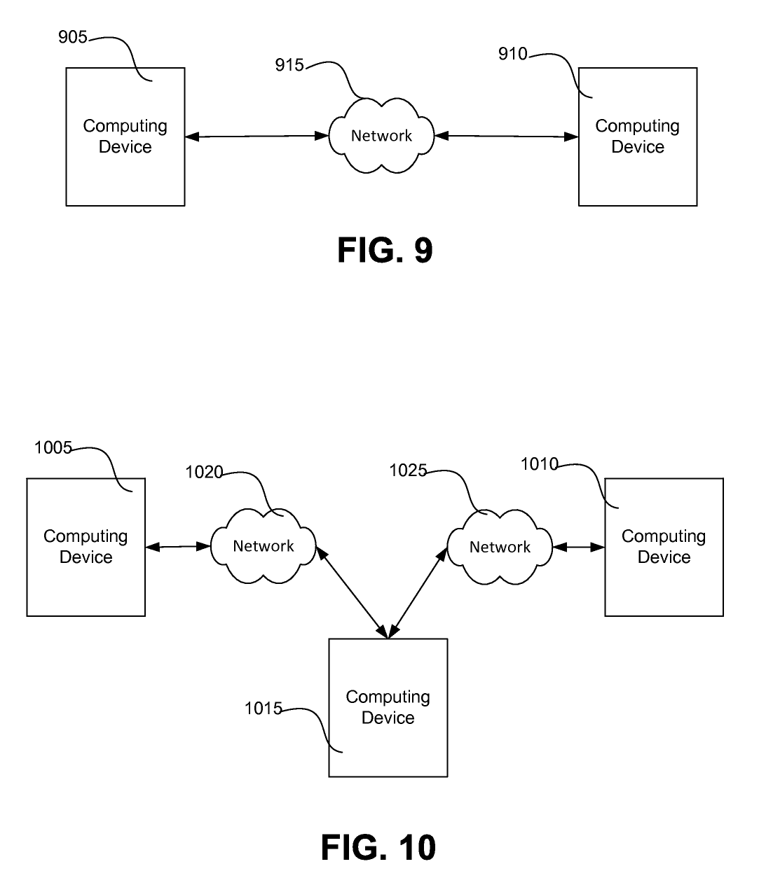

A network is a way for connecting two or more computing devices to each other for communicating information (e.g., data, machine-executable instructions, image files, video files, electronic messages, etc.). Examples of a network include, but are not limited to, a wide area network (e.g., the Internet, an enterprise network), a local area network (e.g., a network of an office, a building, a campus or other relatively small geographic space), a short distance network connection, a telephone network, a data network of a telephone/voice provider (e.g., a mobile communications provider data and/or voice network), another data network, a direct connection between two computing devices (e.g., a peer-to-peer connection), a proprietary service-provider network (e.g., a cable provider network), a wired connection, a wireless connection (e.g., a Bluetooth connection, a Wireless Fidelity (Wi-Fi) connection (such as an IEEE 802.11 connection), a Worldwide Interoperability for Microwave Access connection (WiMAX) (such as an IEEE 802.16 connection), a Global System for Mobile Communications connection (GSM), a Personal Communications Service (PCS) connection, a Code Division Multiplex Access connection (CDMA), and any combinations thereof. A network may employ one or more wired, one or more wireless, and/or one or more other modes of communication. A network may include any number of network segment types and/or network segments. In one example, a network connection between two computing devices may include a Wi-Fi connection between a sending computing device and a local router, an Internet Service Provider (ISP) owned network connecting the local router to the Internet, an Internet network (e.g., itself potentially having multiple network segments) connection connecting to one or more server computing devices and also to a wireless network (e.g., mobile phone) provider of a recipient computing device, and a telephone-service-provider network connecting the Internet to the recipient computing device. Examples of use of a network for transmitting an electronic message and/or a portion thereof are discussed further below (e.g., with respect to FIGS. 9 and 10).

Power supply 630 is shown connected to other components of computing device 605 to provide power for operation of each component. Examples of a power supply include, but are not limited to, an internal power supply, an external power supply, a battery, a fuel cell, a connection to an alternating current power supply (e.g., a wall outlet, a power adapter, etc.), a connection to a direct current power supply (e.g., a wall outlet, a power adapter, etc.), and any combinations thereof.

Components of device 600 (processing element 605, memory 610, camera 615, display component 620, user input 625, interface element 630, power supply 635) are shown as single components. A computing device may include multiple components of the same type. A function of any one component may be performed by any number of the same components and/or in conjunction with another component. For example, it is contemplated that the functionality of any two or more of processing element 605, memory 610, camera 615, display component 620, user input 625, interface element 630, power supply 635, and another component of a computing device may be combined in an integrated circuit. In one such example, a processor (e.g., processing element 605) may include a memory for storing one or more machine executable instructions for performing one or more aspects and/or methodologies of the present disclosure. Functionality of any one or more components may also be distributed across multiple computing devices. Such distribution may be in different geographic locations (e.g., connected via a network). Components of device 600 are shown as internal components to device 600. A component of a computing device, such as device 600, may be associated with the computing device in a way other than by being internally connected.

Components of computing device 600 are shown connected to other components. Examples of ways to connect components of a computing device include, but are not limited to, a bus, a component connection interface, another type of connection, and/or any combinations thereof. Examples of a bus and/or component connection interface include, but are not limited to, a memory bus, a memory controller, a peripheral bus, a local bus, a parallel bus, a serial bus, a SCSI interface, an ATA interface, an SATA interface, an ISA interface, a PCI interface, a USB interface, a FIREWIRE interface, and any combinations thereof. Various bus architectures are known. Select connections and components in device 600 are shown. For clarity, other connections and various other well-known components (e.g., an audio speaker, a printer, etc.) have been omitted and may be included in and/or associated with a computing device in one or more examples. Additionally, a computing device may omit in certain implementations one or more of the shown components.

FIGS. 7A to 7F illustrate one exemplary implementation of a display of an example electronic message showing display movement via a sliding of a display of message content. FIG. 7A shows a computing device 705 (e.g., a handheld device, such as a smartphone) having a user input 710 and a display element 715. In one example, display element 715 may be a touchscreen having an ability to receive input from a user via touch. Display element 715 includes display of a message content display region 720. A message content 725 (in this example, an electronic image) is displayed via display element 715 in message content display region 720. FIG. 7B illustrates an example of message descriptive information 730 corresponding to message content 725. Message descriptive information 730 includes a username (“Amit Shah”) of an originator of message content 725 and a date/time that an electronic message corresponding to message content 725 was sent by the originating user. It is noted that message descriptive information 730 is not displayed via display element 715 at the same time as message content 725.

FIGS. 7C to 7F illustrate a progression of display of message content 725, movement of the display of message content 725, obscuring the display of message content 725, and the display of descriptive information 730. In this example, an instruction is received from a user of device 705 (e.g., via user input 710, via a swipe gesture by a user touching a screen of display element 715, etc.) to move (“slide”) the display of message content 725 to one side (in this example, to the right) of display element 715. Message content 725 is obscured (e.g., in response to the instruction) to form an obscured message content 735, shown in FIG. 7C. FIG. 7C illustrates a display of a portion 740 of display element 715 once occupied by message content display region 720 and message content 725. In this example, message content 725 is obscured from view by blocking the original content using an overlayed graphical filter. Any other partial or full obscuring of message content 725 may also be used. As obscured message content 735 is moved to the side (e.g., via a user pressing and holding one or more fingers on a screen of display element 715 and moving the one or more fingers to the right of the screen). A display of descriptive information 730 is made via display element 715 in portion 740 as obscured message content 735 is moved to the side. In one example, a display of descriptive information 730 slides to the right and begins a display that reveals portions of descriptive information 730 with more of descriptive information 730 being displayed as obscured message content 735 is slid further to the right. FIGS. 7D to 7F show further movement of obscured message content 735 and further display of descriptive information 730. More of the display of obscured message content 735 is terminated as it reaches the side of portion 740. The disappearance of display of obscured message content 735 may, in other examples, start at an edge of a side of display element 715 that is different than the side of portion 740 (e.g., display of parts of obscured message content 735 may extend beyond portion 740) or the display may not disappear at all (e.g., where display element 715 has sufficient displayable area outside of portion 740 to accommodate obscured message content 735).

Instructions for movement from a user may provide for movement in more than one direction. For example, instructions may include instructions for moving obscured message content 735 in multiple directions, for moving obscured message content 735 back to the left to hide part or all of descriptive information 730, instructions for smooth continuous motion of the display of obscured message content 735 and/or descriptive information 730 (e.g., back and forth), instruction for termination of movement of display (e.g., removal of touch from display element 715), and/or instructions for total movement and reveal of descriptive information 730 (e.g., via a single swipe to the side that moves obscured message content 735 and reveals descriptive information 730). In one example, upon termination of movement of display (e.g., via removing a touch from display element 715), message content 725 is returned to its original display and the display of descriptive information 730 is terminated.

FIGS. 8A to 8E illustrate another exemplary implementation of a display of an example electronic message showing display movement via a sliding of a display of message content. For the sake of brevity, some of the details, concepts, aspects, features, characteristics, examples, and/or alternatives discussed with respect to other implementations in this disclosure are not repeated in the discussion of FIGS. 8A to 8E. Any one or more of the like details, concepts, aspects, features, characteristics, examples, and alternatives may apply similarly here, except where noted.

FIG. 8A shows a computing device 805 (e.g., a handheld device, such as a smartphone) having a user input 810 and a display element 815. In one example, display element 815 may be a touchscreen having an ability to receive input from a user via touch. Display element 815 includes a displayable portion 820 including a message content display region 825. In this example, displayable portion 820 also includes the display of several operating environment graphics 830, a navigation control 835 (e.g., for navigating away from the display of message content via message content display region 825), a display of a message content delete control 840, a display of a camera control 845 (e.g., to navigate to a camera functionality of device 805 for acquiring an electronic image, such as to include in a message content), and a display of a text entry field 850 (e.g., to allow for entry of text by a user for inclusion in a message content). A navigation control, such as navigation control 435, 535, or 835, may be configured (e.g., via executable instructions) to be used (e.g., via a user touch of a display, via a point and click instruction of a pointing device, via another user input, etc.) by a user to return to a message listing (e.g., a message tray) showing one or more indicators of messages for a user of a device. A display of a message list can occur in a variety of ways and include a variety of items. Example items for a message list include, but are not limited to, an indication of an outgoing message, an indication of an incoming message, a message descriptive information, one or more components of a message content (e.g., a thumbnail representation of a component of a message content), and any combinations thereof. In one example, a message listing does not include display of a message content or component thereof. A message content delete control, such as control 440, 540, or 840, may be configured (e.g., via executable instructions) to be used (e.g., via a user touch of a display, via a point and click instruction of a pointing device, via another user input, etc.) to delete an electronic message (e.g., that being viewed via the display) and/or any portion thereof. An additional control may be optionally included in a display of a message content and/or message descriptive information for allowing a user to navigate to a separate display of message descriptive information for each of the users (sending and/or receiving) corresponding to a message thread. In one such example, the separate display does not include a message content.

The message content displayed via message content display region 825 includes message content from two originating users in the form of four message contents 855, 860, 865, 870. An electronic message (e.g., the electronic message corresponding to the message content in FIGS. 7A to 7F and 8A to 8E) may include any number of users (senders and recipients), any number of which may originate message content that can be displayed.

FIG. 8B illustrates an example of message descriptive information 872 corresponding to the message content displayed via message content display region 825. Message content 855 originates from a user, Mary Parker, and corresponds to message descriptive information 874, including a username for the originator (“Mary Parker”), date and time information for the date and time message content 855 was sent, and an avatar 876 corresponding to the user, Mary Parker. Message content 860 originates from a user, John Smith, and corresponds to message descriptive information 878 including a username for the originator (“John Smith”), date and time information for the date and time message content 860 was sent, and an avatar 880 corresponding to the user, John Smith. Message content 265 originates from user, Mary Parker, and corresponds to message descriptive information 882 including a username for the originator, date and time information for the date and time message content 865 was sent, and avatar 884 corresponding to the user, Mary Parker. Message content 870 originates from user, John Smith, and corresponds to message descriptive information 886 including a username for the originator, date and time information for the date and time message content 870 was sent, and an avatar 888 corresponding to the user, John Smith.

FIGS. 8C to 8E illustrate a progression of display of message content 855, 860, 865, 870, movement of the display of message content 855, 860, 865, 870, obscuring the display of message content 855, 860, 865, 870, and the display of descriptive information 872. In this example, an instruction is received from a user of device 805 (e.g., via user input 810, via a swipe gesture by a user touching a screen of display element 815, etc.) to move (“slide”) the display of message content 855, 860, 865, 870 to one side (in this example, to the right) of display element 815. Message content 855, 860, 865, 870 is obscured (e.g., in response to the instruction) to form an obscured message content 890, shown in FIG. 8C. FIG. 8C illustrates a display of a portion 895 of display element 815 once occupied by message content display region 825 and message content 855, 860, 865, 870. In this example, each message content 855, 860, 865, 870 is obscured from view by replacement with a message content substitute element. Each of message content 855, 860, 870 is replaced with a display of a textual replacement using “xxxxxx” as a replacement for the corresponding original message content. Message content 865 has the thumbnail of the electronic image replaced with a greyscale graphical message content substitute element. Original message content 855, 860, 865, and 870 are completely obscured. In other examples, any other partial or full obscuring of message content 855, 860, 865, and 870 may also be used.

As obscured message content 890 is moved to the side (e.g., via a user pressing and holding one or more fingers on a screen of display element 815 and moving the one or more fingers to the right of the screen). A display of descriptive information 872 is made via display element 815 in portion 895 as obscured message content 890 is moved to the side. In one example, a display of descriptive information 872 slides to the right and begins a display that reveals portions of descriptive information 872 with more of descriptive information 872 being displayed as obscured message content 890 is slid further to the right. FIGS. 8D to 8F show further movement of obscured message content 890 and further display of descriptive information 872. More of the display of obscured message content 890 is terminated as it reaches the side of portion 895. The disappearance of display of obscured message content 890 may, in other examples, start at an edge of a side of display element 815 that is different than the side of portion 895 (e.g., display of parts of obscured message content 890 may extend beyond portion 895) or the display may not disappear at all (e.g., where display element 815 has sufficient displayable area outside of portion 895 to accommodate obscured message content 890).

Instructions for movement from a user may provide for movement in more than one direction. For example, instructions may include instructions for moving obscured message content 890 in multiple directions, for moving obscured message content 890 back to the left to hide part or all of descriptive information 872, instructions for smooth continuous motion of the display of obscured message content 890 and/or descriptive information 872 (e.g., back and forth), instruction for termination of movement of display (e.g., removal of touch from display element 815), and/or instructions for total movement and reveal of descriptive information 872 (e.g., via a single swipe to the side that moves obscured message content 890 and reveals descriptive information 872). In one example, upon termination of movement of display (e.g., via removing a touch from display element 815), message content 825 is returned to its original display and the display of descriptive information 872 is terminated.

FIG. 9 illustrates one example of a networking environment including a first computing device 905 connected to a second computing device 910 via a network 915. Examples of a computing device are discussed above. Each of computing devices 905 and 910 may include a networking element for allowing connection to network 915. An electronic message and/or any portion thereof (e.g., message content, message descriptive information) may be transmitted from computing device 905 to computing device 910 over network 915. In one example, an electronic message is transmitted from computing device 905 as part of a single transmission (e.g., as one set of data transfer). In another example, different portions (e.g., a message content and message descriptive information) of an electronic message are transmitted separately from computing device 905 as separate files. Separation during transmission may reduce the ability for interception of an entire electronic message. In still another example, electronic message is streamed from computing device 905 (e.g., as a single stream, as multiple streams).

FIG. 10 illustrates another example of a networking environment having a computing device 1005 and a computing device 1010. An electronic message, any portion thereof, and/or other information may be transmitted from computing device 1005 to computing device 1010. An intermediate computing device 1015 exists between computing device 1005 and computing device 1010. In one example, computing device 1015 is one or more server computing devices. In one such example, computing device 1015 is operated by an entity that provides a service to users of computing device 1005 and computing device 1010 that allows those users to perform any one or more of the embodiments, implementations, features, aspects, etc. for electronic messaging and display of message content disclosed herein. Computing device 1005 is connected to computing device 1015 via a network 1020. Computing device 1010 is connected to computing device 1015 via a network 1025. In one example, networks 1020 and 1025 include one or more network segments shared between networks 1020 and 1025. In another example, networks 1020 and 1025 do not share a network segment. An electronic message, any portion thereof, and/or other information may be transmitted from computing device 1005 to computing device 1015 and then to computing device 1010. In one example, an electronic message is transmitted from computing device 1005 and/or computing device 1015 as part of a single transmission (e.g., as one set of data transfer). In another example, different portions (e.g., a message content and message descriptive information) of an electronic message are transmitted separately from computing device 1005 and/or computing device 1015 as separate files. Separation during transmission may reduce the ability for interception of an entire electronic message. In still another example, electronic message is streamed from computing device 1005 and/or computing device 1015 (e.g., as a single stream, as multiple streams).

It is to be noted that any one or more of the aspects and embodiments described herein may be conveniently implemented using one or more machines (e.g., one or more computing devices, such as computing device 600 of FIG. 6) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above that lend themselves to employing software and/or software modules may also include appropriate hardware for assisting in the implementation of the machine executable instructions of the software and/or software module.

Such software may be a computer program product that employs a machine-readable hardware storage medium. A machine-readable hardware storage medium may be any medium that is capable of storing and/or encoding a sequence of instructions for execution by a machine (e.g., a computing device) and that causes the machine to perform any one of the methodologies and/or embodiments described herein. Examples of a machine-readable hardware storage medium include, but are not limited to, a solid state memory, a flash memory, a random access memory (e.g., a static RAM “SRAM”, a dynamic RAM “DRAM”, etc.), a magnetic memory (e.g., a hard disk, a tape, a floppy disk, etc.), an optical memory (e.g., a compact disc (CD), a digital video disc (DVD), a Blu-ray disc (BD); a readable, writeable, and/or re-writable disc, etc.), a read only memory (ROM), a programmable read-only memory (PROM), a field programmable read-only memory (FPROM), a one-time programmable non-volatile memory (OTP NVM), an erasable programmable read-only memory (EPROM), an electrically erasable programmable read-only memory (EEPROM), and any combinations thereof. A machine-readable hardware storage medium, as used herein, is intended to include a single medium as well as a collection of physically separate media, such as, for example, a collection of compact discs or one or more hard disc drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Machine-executable instructions may be provided to a user's computing device at any of a variety of times in relation to the display of an electronic message. In one example, any part of the machine-executable instructions may be provided to a user computing device at the same time or relatively close in time as the time of providing an electronic message to the computing device. In another example, any part of the machine-executable instructions may be provided to a user computing device at a time prior to providing an electronic message. In certain implementations, at least a part of the machine-executable instructions are provided at a time prior to the provision of an electronic message. In one example, at least a part of the machine-executable instructions (e.g., instructions for displaying a message content, moving a display of a message content to a side of a display element, obscuring message content, displaying message descriptive information, etc.) is provided to a recipient computing device as a downloadable application (e.g., an “app”) for execution in conjunction with an electronic message handling method of the present disclosure. In one such example, a downloadable application is provided to a user computing device by an entity that is also responsible for providing access to/transmission of an electronic message (e.g., via one or more server computers of a service provider for creating, sending, receiving, and/or displaying an electronic image). A downloadable application can be provided to a recipient computing device by an entity via any of a variety of ways. Example ways for an entity to provide a downloadable application to a recipient computing device include, but are not limited to, providing access to one or more server computing devices having the application and being operated by the entity and/or an agent of the entity, the entity and/or an agent of the entity providing access to the application via a third-party application download site (e.g., Apple's App Store, Google's Android App Store, etc.), and any combinations thereof. In another example, a segment of machine-executable instructions may be part of an image display codec, part of an operating system, part of a package of an operating system, and/or another application of a computing device. In yet another example, one or more functions for displaying an interface or other displayable element according to any of the aspects, methodologies, and/or implementations of the present disclosure may be performed as a hardware function of a graphics processing unit (GPU and/or CPU)

In another example, at least a part of the machine-executable instructions is provided to a recipient computing device via access by the recipient device to a website that actively provides the display of an electronic message via an interaction with the website and one or more Internet browser applications (or a proprietary application designed for interaction with the website) on the recipient computing device.

Some of the details, concepts, aspects, features, characteristics, examples, and/or alternatives of a component/element discussed above with respect to one implementation, embodiment, and/or methodology may be applicable to a like component in another implementation, embodiment, and/or methodology, even though for the sake of brevity it may not have been repeated above. It is noted that any suitable combinations of components and elements of different implementations, embodiments, and/or methodologies (as well as other variations and modifications) are possible in light of the teachings herein, will be apparent to those of ordinary skill, and should be considered as part of the spirit and scope of the present disclosure. Additionally, functionality described with respect to a single component/element is contemplated to be capable of being performed by a plurality of like components/elements (e.g., in a more dispersed fashion locally and/or remotely). Functionality described with respect to multiple components/elements may be performed by fewer like or different components/elements (e.g., in a more integrated fashion).

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed:

1. A computer-implemented method of handling an electronic message, the method comprising:
displaying a message content display to a first user via a display element of a user device, the message content display including a message content originating from a first originating user;
receiving an instruction from the first user to slide the message content; and
obscuring, in response to the instruction, the message content from view via the display element;
sliding the display of the message content to one side of the display element; and
displaying a message descriptive information regarding the message content such that while the message descriptive information is displayed the message content is not displayed in an unobscured form.

2. A computer-implemented method according to claim 1, wherein a unique identifier of the first originating user is not displayed to the first user while the message content is being displayed.

3. A computer-implemented method according to claim 1, wherein said displaying a message descriptive information occurs while at least a portion of the obscured message content is still visible via the display element.

4. A computer-implemented method according to claim 1, wherein the message content display includes a display of message content from a plurality of originating users.

5. A computer-implemented method according to claim 1, wherein the message content includes a message content selected from the group consisting of a text element, a photo, a video, an audio element, a geolocation coordinate, a sticker graphic and/or image, an emoji graphic and/or image, a graphic element, and any combinations thereof

6. A computer-implemented method according to claim 1, wherein the message content includes a text element.

7. A computer-implemented method according to claim 1, wherein the message content includes a photo.

8. A computer-implemented method according to claim 1, wherein the message descriptive information includes an information selected from the group consisting of a username of one or more originating users corresponding to the message content, an alias of one or more originating users corresponding to the message content, an avatar of one or more originating users corresponding to the message content, a phone number of one or more originating users corresponding to the message content, an email address of one or more originating users corresponding to the message content, a date and/or time of creation of the message content, a date and/or time of transmission of the message content, a phone number of one or more originating users corresponding to the message content, an email address of one or more originating users corresponding to the message content, a date and/or time of receipt of the message content, and any combinations thereof.

9. A computer-implemented method according to claim 1, wherein when the message content is displayed in an unobscured form a message descriptive information corresponding to the message content is not visible to the first user.

10. A computer-implemented method according to claim 1, wherein the first user and the first originating user are the same user.

11. A computer-implemented method according to claim 1, further comprising sending an electronic notification to the first originating user if the first user attempts to capture an image of a display screen of the display element.

12. A machine-readable hardware storage medium comprising machine executable instructions implementing a method of handling an electronic message, the instructions comprising:
a set of instructions for displaying a message content display to a first user via a display element of a user device, the message content display including a message content originating from a first originating user;
a set of instructions for receiving an instruction from the first user to slide the message content;
a set of instructions for, in response to the instruction, obscuring the message content from view via the display element;
a set of instructions for sliding the display of the message content to one side of the display element; and
a set of instructions for displaying a message descriptive information regarding the message content such that while the message descriptive information is displayed the message content is not displayed in an unobscured form.

13. A machine-readable hardware storage medium according to claim 12, wherein a unique identifier of the first originating user is not displayed to the first user while the message content is being displayed.

14. A machine-readable hardware storage medium according to claim 12, wherein said displaying a message descriptive information occurs while at least a portion of the obscured message content is still visible via the display element.

15. A machine-readable hardware storage medium according to claim 12, wherein the message content display includes a display of message content from a plurality of originating users.

16. A machine-readable hardware storage medium according to claim 12, wherein the message content includes a message content selected from the group consisting of a text element, a photo, a video, an audio element, a geolocation coordinate, a sticker graphic and/or image, an emoji graphic and/or image, a graphic element, and any combinations thereof

17. A machine-readable hardware storage medium according to claim 12, wherein the message descriptive information includes an information selected from the group consisting of a username of one or more originating users corresponding to the message content, an alias of one or more originating users corresponding to the message content, an avatar of one or more originating users corresponding to the message content, a date and/or time of creation of the message content, a date and/or time of transmission of the message content, a phone number of one or more originating users corresponding to the message content, an email address of one or more originating users corresponding to the message content, a date and/or time of receipt of the message content, and any combinations thereof.

18. A machine-readable hardware storage medium according to claim 12, wherein when the message content is displayed in an unobscured form a message descriptive information corresponding to the message content are not visible to the first user.

19. A machine-readable hardware storage medium according to claim 12, further comprising a set of instructions for sending an electronic notification to the first originating user if the first user attempts to capture an image of a display screen of the display element.

20. A system for handling an electronic message, the instructions comprising:
a means for displaying a message content display to a first user via a display element of a user device, the message content display including a message content originating from a first originating user;
a means for receiving an instruction from the first user to slide the message content;
a means for, in response to the instruction, obscuring the message content from view via the display element;
a means for sliding the display of the message content to one side of the display element; and
a means for displaying a message descriptive information regarding the message content such that while the message descriptive information is displayed the message content is not displayed in an unobscured form.
